(19) United States
(12) Patent Application Publication
(10) Pub. No.: US 2018/0273806 A1
(43) Pub. Date: Sep. 27, 2018

(54) ADHESIVE STRUCTURE WITH A SUBSTRATE AND AN ADHESIVE COATING

(71) Applicant: Zephyros, Inc., Romeo, MI (US)

(72) Inventors: Xabier Morral, Molsheim Cedex (FR); Francois Crouzet, Molsheim Cedex (FR); Thomas Devanne, Molsheim Cedex (FR); Christian Belanger, Molsheim Cedex (FR)

(73) Assignee: Zephyros, Inc., Romeo, MI (US)

(21) Appl. No.: 15/760,807

(22) PCT Filed: Sep. 28, 2016
(86) PCT No.: PCT/EP2016/073080

§ 371 Date: Mar. 16, 2018

(30) Foreign Application Priority Data
Sep. 28, 2015 (EP) 15187152.2

(51) Int. Cl. C09J 7/22; C09J 7/28; C09J 9/00

(52) U.S. Cl. CPC C09J 7/22; C09J 7/28; C09J 2201/40; C09J 2201/28; C09J 9/00

(57) ABSTRACT

The present invention relates to an adhesive structure (6) comprising a substrate (1) and an adhesive coating (7) is applied to the substrate. The adhesive coating is applied to the substrate so that the thickness (z) of the coating varies in at least one direction (x, y).

The present invention relates to an adhesive structure comprising a substrate and an adhesive coating is applied to the substrate.

Such adhesive structures are well known from the state of the art. However, there is a constant need to improve such adhesive structures.

It is therefore the objective of the present invention to provide an improved adhesive structure.

The problem is attained by an adhesive structure comprising a substrate and an adhesive coating applied to the substrate, wherein the thickness of the coating varies in at least one direction.

The disclosure made regarding this subject matter also applies to the other subject matters and vice versa.

The present invention relates to an adhesive structure which can be permanently attached to another structure. Therefore, the adhesive structure comprises a substrate, which is the part that shall be glued to the other structure. The substrate is at least partially coated with an adhesive structure.

The adhesive coating applied to the surface of the substrate is preferably a heat activatable adhesive and the temperature at which the adhesive is activated will depend upon the nature of the adhesive and the nature of the activation and when the activation is to take place. For example, it may be desirable that the adhesive adheres to the surface of the substrate but remains at a temperature at which it remains activatable by subsequent heating (such as by thermal cross linking and/or thermal expansion). Prior to its activation, the adhesive powder preferably only comprises a stickiness that is sufficient to maintain the adhesive power on the substrate.

In order to form a desirable adhesive that exists first preferably in powder form, can then fuse to form a film layer, and later be activated to cure, the adhesive (e.g., the precursor layer) may include an epoxy based material. The epoxy may be any dimeric, oligomeric or polymeric epoxy materials containing at least one epoxy functional group. Moreover, the term epoxy can be used to denote one epoxy or a combination of multiple epoxies. The polymer-based materials may be epoxy-containing materials having one or more oxirane rings polymerizable by a ring opening reaction. A precursor layer may include up to 80% or more of an epoxy. The precursor layer may include between 2% and 70% by weight epoxy, between 4% and 30% by weight epoxy, or even between 7% and 18% by weight epoxy. The adhesive may be substantially free of an epoxy material (other than any epoxy supplied in the form of an epoxy/elastomer adduct). The epoxy may be aliphatic, cycloaliphatic, aromatic or the like. The epoxy may be supplied as a solid (e.g., as pellets, chunks, pieces or the like) or a liquid. The epoxy may include an ethylene copolymer or terpolymer that may possess an alpha-olefin. Preferably, an epoxy is added to the precursor layer to increase the adhesion, flow properties or both of the precursor layer. The epoxy may include a phenolic resin, which may be a novolac type (e.g., an epoxy phenol novolac, an epoxy cresol novolac, combinations thereof, or the like) or other type resin. Other preferred epoxy containing material includes a bisphenol-A epichlorohydrin ether polymer, or a bisphenol-A epoxy resin which may be modified with butadiene or another polymeric additive. Moreover, various mixtures of several different epoxies may be employed as well. Examples of suitable epoxies are sold under the trade name DER® (e.g., DER 331, DER 661, DER 662), commercially available from the Dow Chemical Company, Midland, Mich.

The epoxy may be combined with a thermoplastic component, which may include styrenics, acrylonitriles, acrylates, acetates, polyamides, polyethylenes, phenoxy resins or the like. The thermoplastic component may be present in an amount of at least 5% by weight of the precursor layer. The thermoplastic component may be present in an amount of at least 20% by weight of the precursor layer. The thermoplastic component may be present in an amount of at least 60% by weight of the precursor layer. The thermoplastic component may be present in an amount of less than 80% by weight of the precursor layer. The thermoplastic component may be present in an amount of less than 30% by weight of the precursor layer.

While it is contemplated that various polymer/elastomer adducts may be employed according to the present invention, one preferred adduct is an epoxy/elastomer adduct. The precursor layer may thus include an elastomer-containing adduct. The epoxy/elastomer hybrid or adduct may be included in an amount of up to 80% by weight of the precursor layer. The elastomer-containing adduct may be approximately at least 5%, more typically at least 7% and even more typically at least 10% by weight of the precursor layer. The adduct may be up to 60% or more, but more preferably is 10% to 30% by weight of the precursor layer. Of course, the elastomer-containing adduct may be a combination of two or more particular adducts and the adducts may be solid adducts or liquid adducts at a temperature of 23° C. or may also be combinations thereof. The adduct may be composed of substantially entirely (i.e., at least 70%, 80%, 90% or more) of one or more adducts that are solid at a temperature of 23° C.

The adduct itself generally includes 1:8 to 3:1 parts of epoxy or other polymer to elastomer, and more preferably 1:5 to 1:6 parts of epoxy to elastomer. More typically, the adduct includes at least 5%, more typically at least 12% and even more typically at least 18% elastomer and also typically includes not greater than 50%, even more typically no greater than 40% and still more typically no greater than 35% elastomer, although higher or lower percentages are possible. The elastomer compound may be a thermosetting elastomer. Exemplary elastomers include, without limitation, natural rubber, styrene-butadiene rubber, polyisoprene, polyisobutylene, polybutadiene, isoprene-butadiene copolymer, neoprene, nitrile rubber (e.g., a butyl nitrile, such as carboxy-terminated butyl nitrile), butyl rubber, polysulfide elastomer, acrylic elastomer, acrylonitrile elastomers, silicone rubber, polysiloxanes, polyester rubber, diisocyanate-linked condensation elastomer, EPDM (ethylene-propylene diene rubbers), chlorosulphonated polyethylene, fluorinated hydrocarbons and the like. An example of a preferred epoxy/elastomer adduct is sold under the trade name HYPDX commercially available from CVC Chemical.

The adhesive coating may be used to provide structural- and/or sealing-adhesives. The inventive adhesive structure is preferably used in the automotive industry, aerospace industry, building industry and/or furniture industry.

According to the present invention, the thickness of the coating varies at least in one direction of the surface of the substrate. Preferably, these directions are perpendicular to each other. This variation in thickness can be achieved, by applying locally more adhesive material than in an adjacent region. The transition between two regions can be stepwise and/or according to a ramp and/or according to a curve or the like.

Due to the variation in the thickness of the adhesive coating, the adhesion between the structure and the substrate can be improved. For example: the thickness of the coating can be adapted to the topology of the surface of the substrate and/or the contact between the adhesive coating and the structure can be in a certain sequence and/or the strength of the adhesion between the substrate and the structure can be adjusted locally.

The adhesive coating normally does not cover an entire surface of the substrate, but is applied locally, for example as a strip, dot or the like.

Another inventive or preferred embodiment of the present invention is an adhesive structure wherein the coating comprises one or, at least locally, more layers.

The disclosure made regarding this subject matter also applies to the other subject matters and vice versa.

According to this embodiment of the present invention, the coating comprises at least one layer and can comprise at least locally more than one layer. The layers may be made from the same or different materials.

However, according to another inventive or preferred embodiment of the present invention, the composition of the adhesive coating differs locally.

The disclosure made regarding this subject matter also applies to the other subject matters and vice versa.

This embodiment of the present invention has the advantage that the composition of the adhesive layer can be adjusted to local needs. The change of the composition can take place in one layer and/or can be implemented by two or more layers which are staged on top of each other and/or which are situated side by side.

Preferably, the adhesive coating comprises at least one layer whose composition differs locally. This can be achieved by a side by side arrangement of two or more compositions in sequence and/or in parallel.

According to a preferred embodiment of the present of the present invention, the layers of the coating can differ in their local thickness and/or their local width and/or their length and/or their composition.

According to another preferred or inventive embodiment of the present invention, at least one layer comprises a recess.

The disclosure made regarding this subject matter also applies to the other subject matters and vice versa.

Preferably, the coating of the adhesive structure comprises a structural- and/or a sealing adhesive.

According to a preferred embodiment of the present invention, the substrate is made from metal and/or a plastic material.

Preferably, at least one layer is made from a powder adhesive material.

The inventions are now explained according to the figures. These explanations apply to all inventions of the present application likewise. The explanations are only exemplary and do not limit the scope of protection.

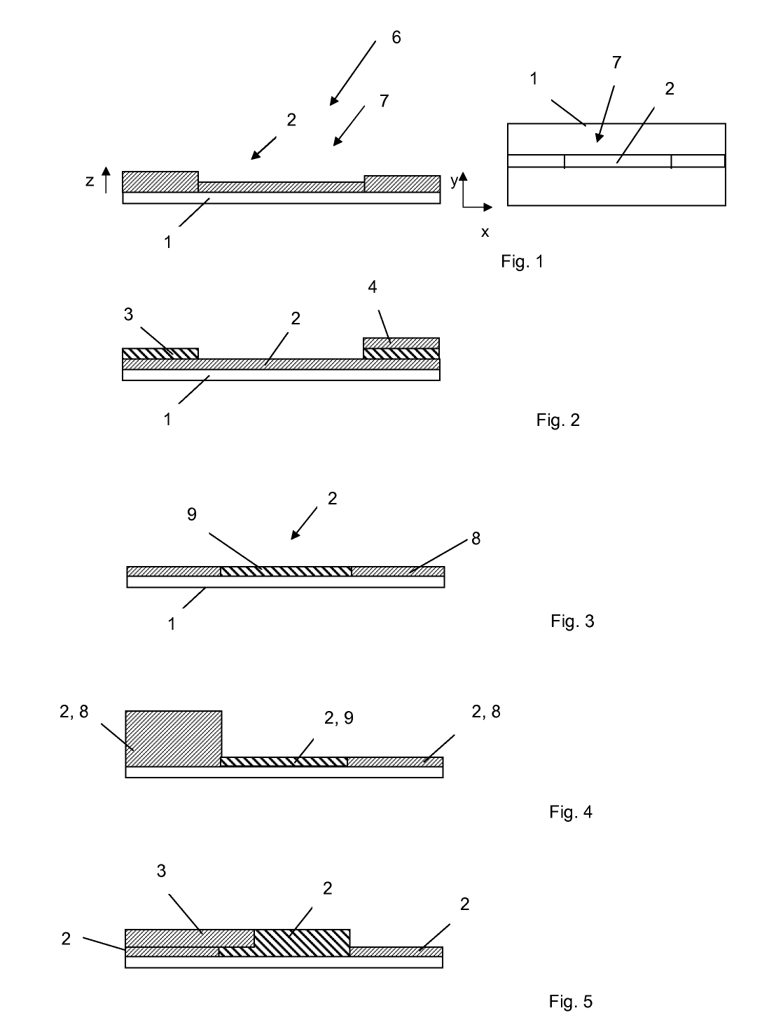

FIG. 1 shows a substrate with an adhesive coating with one layer.

FIG. 2 shows a substrate with an adhesive coating with three layers.

FIGS. 3 and 4 show two embodiments with an adhesive coating with one layer.

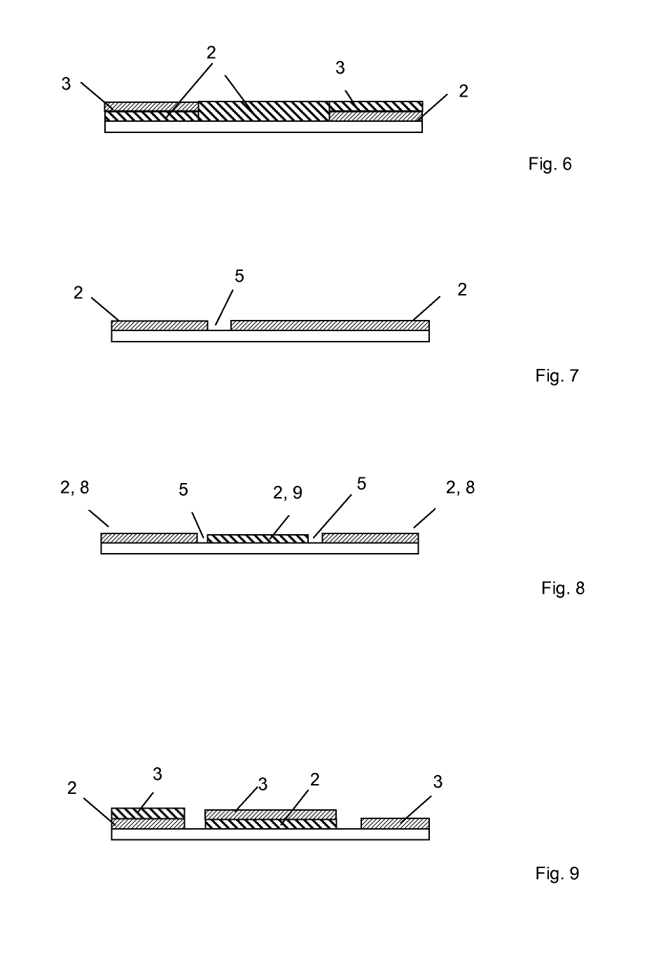

FIGS. 5 and 6 show two embodiments with an adhesive coating with one layer.

FIGS. 7-9 show an embodiment with a recess in one layer.

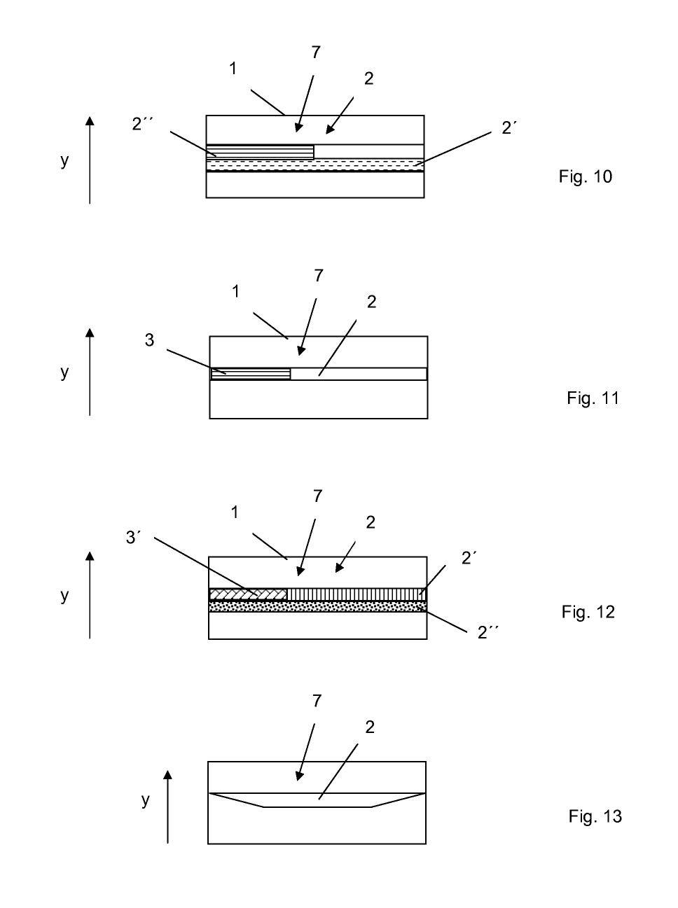

FIGS. 10-12 show top views of embodiments with layers made from at least two compositions.

FIG. 13 shows an embodiment wherein the width of the layer varies.

FIG. 1 shows a first embodiment of the inventive adhesive structure in two views. The adhesive structure 6 comprises a substrate made, for example, from metal, a plastic material or a combination thereof. On the surface of the substrate, an adhesive coating 7 is provided as a strip, as can be seen from the view on the right hand side. This adhesive coating allows to bond the substrate to another structure (not depicted). In the present case the adhesive coating comprises only one layer, which, however has locally different heights, i.e. extension in z-direction. In the present case, the ends on the right- and left hand side have a greater height than the height in the middle. The person skilled in the art, however, understands that the height distribution can be differently. In the present case, the adhesive coating strip extends over the entire length x of the substrate and has a constant width y. Again, the person skilled in the art understands that this can be different as well. The height and/or width and/or length of the adhesive coating 7 is provided as needed, particularly dependent on the locally required bonding forces.

FIG. 2 shows an embodiment of the inventive adhesive structure, wherein, in the present case, the adhesive coating comprises three layers. Again, it should be noted that the layers 2-4 can be different in their length x, width y and height z to create a taylor made adhesive connection.

The embodiments according to FIGS. 3 and 4 depict that the composition of one layer 2 can comprise one or more different substances 8, 9, which are different, for example comprise different adhesive properties. In the example according to FIG. 3, the thickness z of the two substances is the same, while in the example according to FIG. 4 the thickness of the layer with the composition 8 varies and/or is locally different than the composition 9.

In the example according to FIGS. 5 and 6, it can be seen that the length x of a composition in the layer can vary over its height z. It can also be seen that the sequence of compositions can vary over the height of the adhesive coating 7. The person skilled in the art understands that width y of a composition within one layer can also vary over its height.

FIGS. 7-9 show each an embodiment of the inventive adhesive structure, wherein at least one layer 2 comprises a recess 5, which can be, for example, utilized for attaching, e.g. welding the substrate 1 to another structure. The recess can be smaller than the width y of the adhesive coating. It can have the same or different height than the layer itself in the vicinity of the recess. Referring to FIG. 8, two substances 8, 9 can be separated by a recess 5. As can be seen from FIG. 9, a recess can extent through more than one layer and/or the thickness of the adhesive coating layer may vary around the recess.

FIGS. 10-12 show each a top view of the inventive adhesive structure. Each Figure depict that the composition of one or more layers can also vary in the width y. and/or in its length x. One layer 2 may comprise of two of more compositions, which are arranged in a side by side configuration 2′, 2″ in the y-direction (FIG. 10) or in a sequential configuration in the x-direction.

FIG. 13 shows that the width y of one component and/or layer need not be constant over the length of the adhesive coating.

### REFERENCE SIGNS

1 substrate
2 first layer
2′ first layer
2″ first layer
3 second layer
4 third layer
5 recess
6 adhesive structure
7 adhesive coating
8 first substance
9 second substance

1: An adhesive structure comprising a substrate and an adhesive coating applied to the substrate, characterized in that the thickness (z) of the coating varies in at least one direction (x, y).

2: The adhesive structure according to claim 1, characterized in that the coating comprises one or, at least locally, more layers.

3: The adhesive structure according to claim 1, characterized in that the composition of the adhesive coating differs locally.

4: The adhesive structure according to claim 3, characterized in that the adhesive coating comprises at least one layer whose composition differs locally.

5: The adhesive structure according to claim 2, characterized in that the layers of the coating differ in their thickness (z) and/or their width (y) and/or their length (x) and/or their composition.

6: The adhesive structure according to claim 1, characterized in that a least one layer comprises a recess.

7: The adhesive structure according to claim 1, characterized in that the coating comprises a structural-and/or a sealing adhesive.

8: The adhesive structure according to claim 1, characterized in that the substrate is made from metal and/or a plastic material.

9: The adhesive structure according to claim 1, characterized in that the layers are made from a powder adhesive material.

10: The adhesive structure according to claim 1, wherein the structure includes at least three adhesive layers.

11: The adhesive structure according to claim 1, wherein the width of at least one layer varies.

12: The adhesive structure according to claim 1, including a first layer having a constant width and a second layer having a varying width.

13: The adhesive structure according to claim 1, including a first layer formed of one or more strips and a second layer formed of one or more dots.

14: The adhesive structure according to claim 1, including a first layer having a length that is the same as the length of an adjacent second layer but a width that differs from the width of the adjacent second layer.

15: The adhesive structure according to claim 1, including a first layer having a length that is the same as the length of an adjacent second layer but a height that differs from the height of the adjacent second layer.

16: The adhesive structure according to claim 1, including a first layer having a height that is the same as the height of a second layer in a green state, but after activation, the height of the second layer is greater than the height of the first layer.

17: The adhesive structure according to claim 1, wherein the substrate has at least one layer on a first portion of the substrate and at least two layers on a second portion of the substrate.

18: The adhesive structure according to claim 1, including a first adhesive composition that forms the first layer on a first portion of the substrate and forms the second layer on a second portion of the substrate.

19: The adhesive structure according to claim 18, wherein the first adhesive forms a third layer on a third portion of the substrate.

20: The adhesive according to claim 1, wherein at least one adhesive composition is an activatable composition.
